(19) United States
(12) Patent Application Publication
(10) Pub. No.: US 2006/0077838 A1
(43) Pub. Date: Apr. 13, 2006

(54) Optical disk device and startup method of optical disk

(75) Inventor: Tadashi Sasaki, Iruma-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TEAC Corporation

(21) Appl. No.: 11/248,915

(22) Filed: Oct. 11, 2005

(30) Foreign Application Priority Data
Oct. 13, 2004 (JP) 2004-298784

(51) Int. Cl. G11B 7/00

(52) U.S. Cl. 369/47.55; 369/53.2; 369/53.45

(57) ABSTRACT

Time required for identification of a type of an optical disk and notification of error in an optical disk device is shortened. In an optical disk device which identifies among a plurality of types of optical disks and starts up, a data processor limits a group of startup modes to be selected in subsequent processes from among a group of startup modes stored in a storage device based on obtained related information related to an inserted optical disk when a startup error occurs in a startup process. The data processor selects a next startup mode from among the limited group of startup modes and controls a driver circuit through a drive controller to perform a startup process.

### BACKGROUND OF THE INVENTION

1. Field of the Invention

The present invention relates to an optical disk device, and in particular to an optical disk device which identifies among a plurality of types of optical disks, and starts up.

2. Description of the Related Art

Conventionally, a plurality of types of optical disks are available such as a DVD-ROM, a CD-ROM, a CD-R, and a CD-RW. Regarding an optical disk device which records and/or replays using the disks as a recording medium, on the other hand, various devices are proposed which can handle a plurality of types of disks. Thus, a method is desired for quickly and accurately identifying the type of disk when the disk is inserted.

FIG. 6 shows an example process when an optical disk device of related art identifies the type of the disk. In an optical disk device of related art, when a disk is inserted, the type of the inserted disk is identified (S1). More specifically, light is emitted from LD (laser diode) for CD or LD for DVD and a focus search operation is performed. Using a sum signal and a focus error signal which are generated based on the reflection light, the disk is identified as a CD-based disk or a DVD-based disk. The disk is also identified as a high reflection disk or a low reflection disk based on the amount of reflected light (for example, refer to Japanese Patent Laid-Open Publication No. 2001-184676).

A startup mode corresponding to the inserted disk is selected based on the identification result at S1 (S2) and a startup process is performed in the selected startup mode (S3). More specifically, an actuator which supports an objective lens is driven along the optical axis direction to perform a focus search process while laser light having a wavelength corresponding to the type of disk is emitted so that focus is achieved. Then, a tracking servo is activated to maintain correct tracking, related information related to the inserted disk is obtained, and the startup process is completed.

When the startup process is not completed, it is determined whether or not there is a startup mode which has not been attempted (S5). When there is a startup mode which has not been attempted, this startup mode is selected (S6) and the startup process is performed again. The optical disk device repeats this operation when the startup is not completed. When the startup is not successfully completed even after all startup modes are attempted, the optical disk device outputs an instruction for disk error notification (S7) and notifies the user of the error by displaying on a display or the like. Related references include Japanese Patent Laid-Open Publication Nos. 2001-184676, 2003-178445, and 2000-182313.

When the startup process is performed while the startup modes are switched, however, it is necessary to switch between laser diodes based on the startup mode and locking of the focus servo and tracking servo at each attempt of the startup mode. Thus, there may be cases in which the time required for completion of startup or time required for error notification becomes long.

As a method of reducing the startup time, Japanese Patent Laid-Open Publication No. 2003-178445 discloses a method in which the user first designates the type of the inserted disk when inserting the disk, and then the optical disk device automatically identifies the type of the optical disk. However, the user does not necessarily know the type of the optical disk being inserted, and thus the startup time may not be reduced in some cases.

### SUMMARY OF THE INVENTION

The present invention advantageously reduces the time required for identification of a type of an optical disk and the time required for error notification in an optical disk device.

According to one aspect of the present invention, there is provided an optical disk device which identifies among a plurality of types of optical disks, and then starts up, the optical disk device comprising an identification unit which identifies a type of an optical disk which is inserted, a selection unit which selects a startup mode, corresponding to an identified type of an optical disk, from a storage device which stores a startup mode corresponding to a type of an optical disk, a startup unit which performs a startup process based on a selected startup mode, an obtaining unit which obtains related information related to the optical disk which is obtained during the startup process by the startup unit, and a mode limiting unit which limits a group of startup modes to be selected by the selection unit from among a group of startup modes stored in the storage device based on obtained related information when a startup error occurs during the startup process, wherein the selection unit selects a next startup mode from among the group of startup modes limited by the mode limiting unit when a startup error occurs during the startup process.

In the present invention, when a startup error occurs during the startup process of the optical disk, the mode limiting unit limits a group of startup modes to be selected by the selection unit from among a group of startup modes stored in the storage device based on related information obtained by the obtaining unit. With this configuration, because the number of startup modes to be subsequently attempted is reduced when a startup error occurs, the time required for identification of the type of the optical disk and for notification of an error can be reduced.

According to another aspect of the present invention, it is preferable that, in the optical disk device, when the related information is information unique to a CD-based optical disk, the mode limiting unit limits the group of startup modes to CD-based startup modes.

In the present invention, when the related information is information unique to a CD-based system, for example, when ATIP information and SubQ information are obtained from an inserted optical disk without a problem, the inserted optical disk is determined to be a CD-based disk and the mode limiting unit limits the group of startup modes to CD-based startup modes. In this manner, because the startup modes to be attempted at the subsequent steps are limited to the CD-based startup modes, the time required for identification of the type of the optical disk and for notification of an error can be reduced.

According to another aspect of the present invention, it is preferable that, in the optical disk device, when the related information is information unique to a DVD-based optical disk, the mode limiting unit limits the group of startup modes to DVD-based startup modes.

In the present invention, when the related information is information unique to a DVD-based system, the inserted optical disk is determined to be a DVD-based disk and the mode limiting unit limits the group of startup modes to the DVD-based startup modes. For example, when information such as SectorID, LPP, and CAPA are obtained from the inserted optical disk without a problem, when the startup mode when the startup error occurred is a DVD-based mode using a phase difference method and the focus servo and the tracking servo become an ON state, or when the startup mode when the startup error occurred is a DVD-based mode using a push-pull method, the focus servo and tracking servo become an ON state, and the wobble frequency is determined to fall within a predetermined range, the mode limiting unit limits the group of startup modes to the DVD-based startup modes. With this configuration, because the startup modes to be attempted in subsequent steps are limited to the DVD-based startup modes, the time required for identification of the type of the optical disk and for notification of error can be reduced.

### BRIEF DESCRIPTION OF THE DRAWINGS

A preferred embodiment of the present invention will be described in detail with reference to the drawings, wherein:

FIG. 1 is a diagram showing structural blocks in an optical disk device according to a preferred embodiment of the present invention;

FIG. 2 is a flowchart showing an identification process, for identifying type of inserted optical disk and startup process, in an optical disk device according to a preferred embodiment of the present invention;

FIG. 3 is a flowchart exemplifying a startup process when the startup mode is a CD-based startup mode (high-reflection CD startup mode and low-reflection CD startup mode) in an optical disk device according to a preferred embodiment of the present invention;

FIG. 4 is a flowchart exemplifying a startup process when the startup mode is a DVD-based startup mode (high-reflection DVD startup mode and low-reflection DVD startup mode) in an optical disk device according to a preferred embodiment of the present invention;

FIG. 5 is a flowchart exemplifying a startup mode narrow-down process which is executed when a startup error occurs in an optical disk device according to a preferred embodiment of the present invention; and

FIG. 6 is a flowchart showing an identification process of type of inserted optical disk and the startup process in an optical disk device of related art.

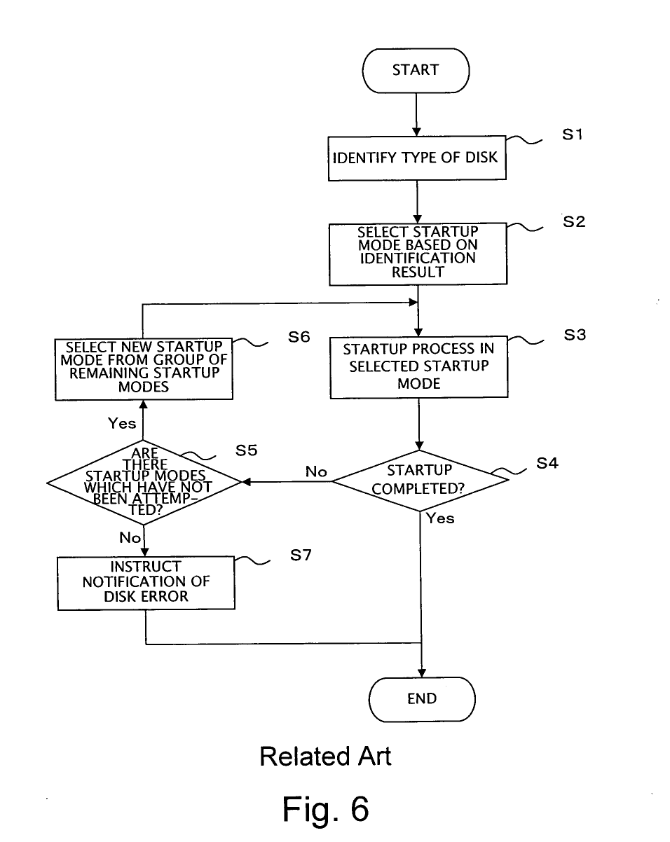

### DESCRIPTION OF THE PREFERRED EMBODIMENT

A preferred embodiment of the present invention (hereinafter simply referred to as “embodiment”) will now be described referring to the drawings and exemplifying an optical disk device.

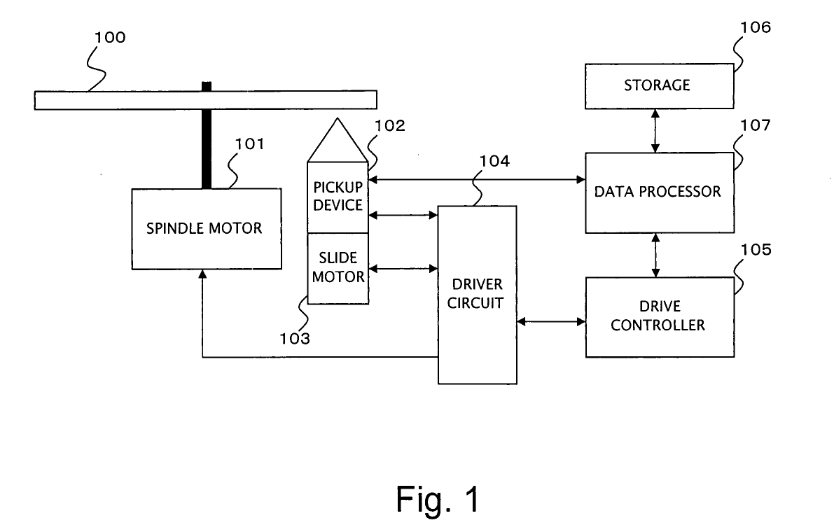

FIG. 1 is a structural block diagram showing a preferred embodiment of the present invention. As shown in FIG. 1, an optical disk device of the preferred embodiment of the present invention comprises an optical disk 100 such as a DVD-ROM and a CD-ROM on which data is recorded, a spindle motor 101 which rotates the optical disk 100, a pickup device 102, a slide motor which moves the pickup device 102 along the radial direction of the optical disk 100, a driver circuit 104 which drives the spindle motor 101, a drive controller 105 which controls the driver circuit 104, a storage 106 which stores a control program, control parameter, etc. for controlling an operation such as recording and replaying of the optical disk 100, and a data processor 107 which performs a type identification process for identifying a type of inserted optical disk 100, drive control through the drive controller 105 during boot up (startup process) until a data recording or replaying process is started based on the identified type or recording/replaying of the optical disk 100, data process, etc.

Each element in the disk replay device in the present embodiment will now be described in detail including the operations. The position of the pickup device 102 is adjusted using a focus drive signal, a tracking drive signal, and a thread drive signal from the driver circuit 104. The pickup device 102 reads information from the optical disk 100 and converts the read information to an electrical signal. The spindle motor 101 controls rotation of the optical disk 100 based on a drive signal of the spindle from the driver circuit 104. The slide motor 103 moves the pickup device 102 along the radial direction of the optical disk 100 based on a drive signal from the driver circuit 104 to adjust the position of the pickup device 102.

The driver circuit 104 reads a control signal from the drive controller 105 and a tracking error signal, a focus error signal, and an eye pattern signal from the pickup device 102, and performs a focus servo control process, a tracking servo control process, a spindle servo control process, and a thread servo control process. The drive controller 105 controls the driver circuit 104 based on the status from the driver circuit 104.

The data processor 107 is realized by a CPU or DSP (Digital Signal Processor). These units only indicate functional blocks and are realized through a program executed on the CPU or DSP.

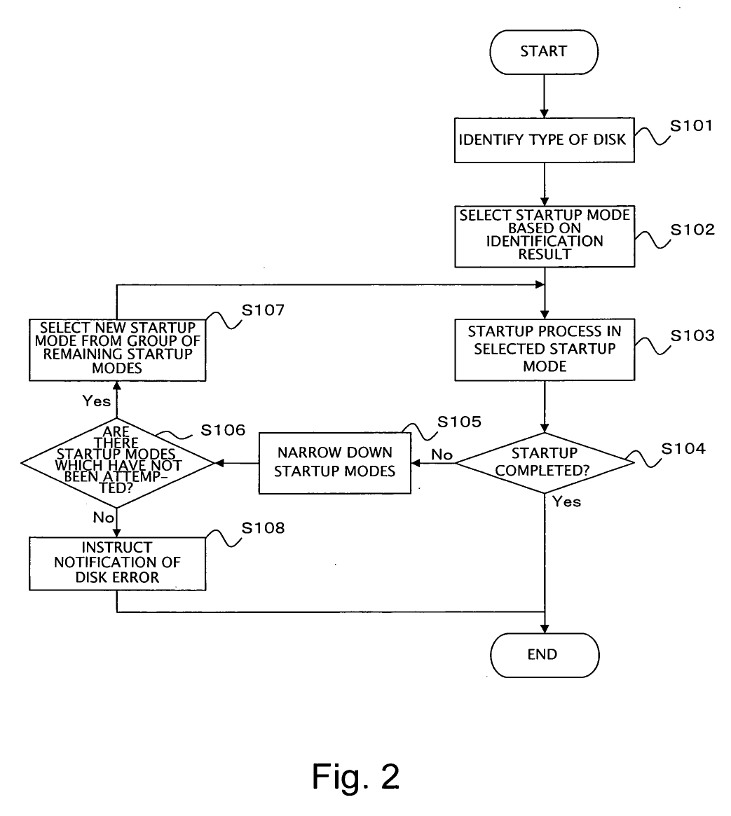

In the present embodiment thus configured, when an optical disk 100 is inserted, the data processor 107 identifies the type of the disk and performs a startup process corresponding to the identification result as shown in the flowchart of FIG. 2.

A characteristic of the present embodiment is that when a startup process is not completed even through the startup process is performed in a startup mode selected based on the identification result at step S101, the startup modes to be selected at subsequent attempts are narrowed down in step S105 based on related information related to the optical disk which is obtained during the startup process at step S103. By narrowing the startup modes down, in the present embodiment, it is possible to reduce the number of startup modes to be separately selected when the startup process in the selected startup mode is not completed so that the process time required until the startup process is completed or for notification of a disk error is reduced.

Details of the processes in the flowchart of FIG. 2 will now be described.

Referring to FIG. 2, the data processor 107 identifies the type of the inserted disk (S101). More specifically, as described above, light is emitted from an LD (laser diode) for CD or LD for DVD to perform a focus search operation. Then, the optical disk is identified as a CD-based disk or a DVD-based disk though a sum signal and a focus error signal generated based on the reflection light during the focus search operation and is identified as a high-reflection disk or a low-reflection disk based on the amount of reflection and by determining whether the amount of reflection is high or low compared to a predetermined reference value.

The data processor 107 selects a startup mode according to the identification result at step S101. The startup modes include, for example, four startup modes including a CD high-reflection startup mode, a CD low-reflection startup mode, a DVD high-reflection startup mode, and a DVD low-reflection startup mode. The CD high-reflection startup mode is a mode which starts without a problem when the inserted optical disk is a CD-based optical disk, particularly CD-ROM and CD-R. The CD low-reflection mode is a mode which starts without a problem when the inserted optical disk is a CD-based optical disk, particularly CD-RW. The DVD high-reflection mode is a mode which starts without a problem when the inserted optical disk is a DVD-based optical disk, particularly a DVD-ROM and DVD-R. The DVD low-reflection mode is a mode which starts without a problem when the optical disk is a DVD-based optical disk, particularly DVD-RW. A startup mode is selected from among the group of these startup modes according to the identification result at step S101.

Then, the data processor 107 controls the driver circuit 104 through the drive controller 105 to perform a startup process in a startup mode selected in step S102 (S103).

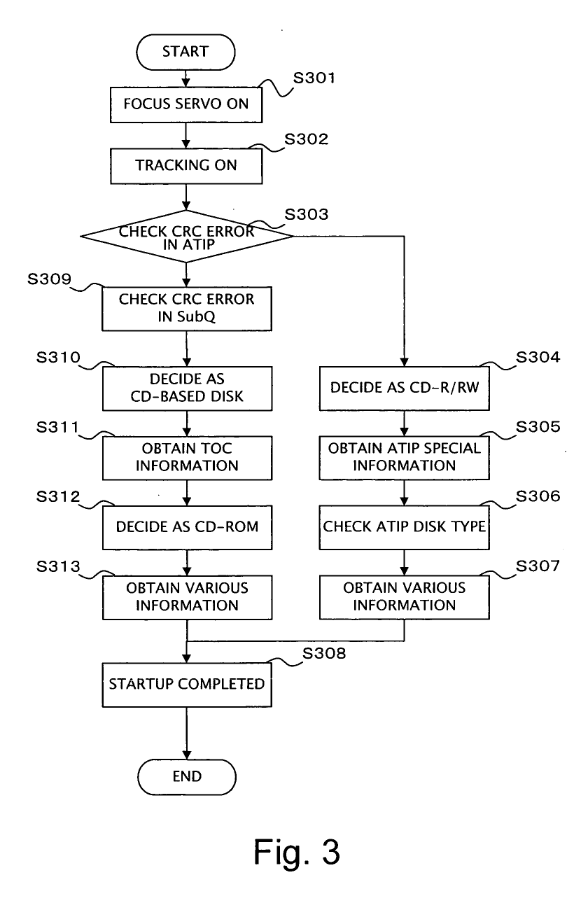

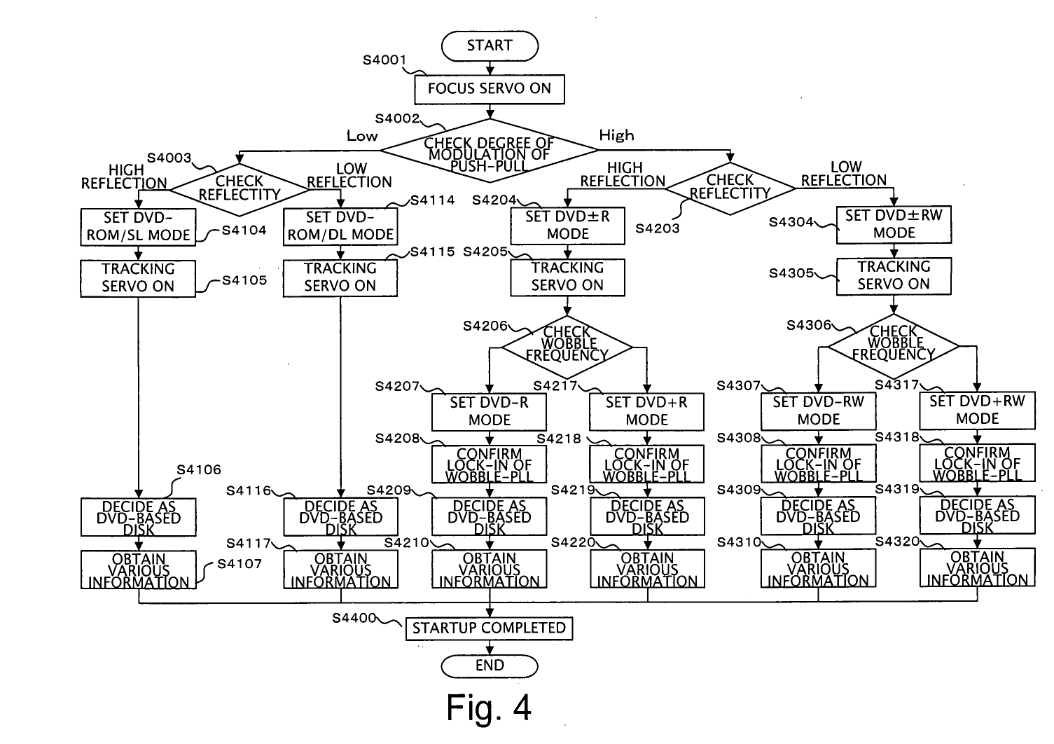

Details of the startup process will now be described referring to FIGS. 3 and 4 for a CD-based system and a DVD-based system, respectively.

FIG. 3 is a flowchart showing a startup process in a CD high-reflection startup mode and a CD low-reflection startup mode.

The driver circuit 104 drives the pickup device 102 in the focus direction based on a focus error signal to achieve an on-focus state (S301) and drives the pickup device 102 in the tracking direction of the optical disk 100 based on a tracking error signal to achieve an on-track state (S302). Then, the data processor 107 obtains ATIP (Absolute Time In Pre-groove) information from the optical disk 100 via the pickup device 102, checks for a CRC error, and determines presence of the CRC error (S303). When there is no CRC error, the data processor 107 determines that the inserted optical disk 100 is a CD-R or a CD-RW (S304). Then, the ATIP special information is obtained (S305) and an ATIP disk type is identified based on this information (S306). In this manner, the inserted optical disk 100 is determined to be a CD-R or CD-RW (MS, HS, US, US+). The data processor 107 further obtains various information related to the inserted optical disk 100 (such as PMA information, TOC information, Method2 information, etc.) (S307) and the startup process is completed (S308).

When, on the other hand, ATIP information cannot be obtained in the determination of step S303 or a CRC error is present, the data processor 107 obtains SubQ information from the optical disk 100 via the pickup device 102, checks for a CRC error, and determines whether or not there is a CRC error (S309). When there is no CRC error, the inserted optical disk 100 is determined to be a CD-based optical disk (S310). The data processor 107 obtains TOC information from the optical disk 100 (S311) to determine that the inserted optical disk 100 is a CD-ROM (S312). Then, the data processor 107 obtains various information related to the inserted optical disk 100 (such as Method2 information) (S313) and completes the startup process (S308).

In the above-described process, when the focus servo or the tracking servo does not become an ON-state or when the related information related to the inserted optical disk 100 such as the SubQ information, TOC information, and ATIP special information cannot be obtained, the data processor 107 determines that the startup process is not completed. When the startup process is not completed, a process in step S105 of the flowchart of FIG. 2, that is, a narrow-down process of the startup modes, is performed. Details of this process will be described later.

Next, a startup process in the DVD high-reflection startup mode and the DVD low-reflection startup mode will be explained referring to the flowchart of FIG. 4.

The data processor 107 controls the driver circuit 104 through the drive controller 105 to drive the pickup device 102 along the focus direction based on a focus error signal to achieve an ON-focus state (S4001), checks degree of modulation of PushPull, and determines that the tracking error signal is to be generated through a phase difference method when the degree of modulation is low and that the tracking error signal is to be generated through a push-pull method when the degree of modulation is high (S4002).

When it is decided in step S4002 that the phase difference method is to be employed, a reflectivity of the inserted optical disk 100 is checked (S4003). The startup mode is set to a DVD-ROM/SL mode when the reflectivity is high (S4104) and the startup mode is set to a DVD-ROM/DL mode when the reflectivity is low (S4114). Then, the tracking servo is set to an ON-track state in each mode (S4105 and S4115), and when the tracking servo is in the ON-track state, the inserted optical disk 100 is determined to be a DVD-based optical disk (S4106 and S4116). Various information regarding the optical disk 100 (such as control information) is obtained (S4107 and S4117) and the startup process is completed (S4400).

When, on the other hand, it is decided in step S4002 that the push-pull method is to be employed, a reflectivity of the inserted optical disk is determined (S4203). The startup mode is set to a startup mode for DVD±R when the reflectivity is high (S4204) and the startup mode is set to a startup mode for DVD±RW when the reflectivity is low (S4304). Then, the tracking servo is set to an ON-track state in each mode (S4205 and S4305). When the tracking servo is set to the ON-track state, the wobble frequency is checked (S4206 and S4306). The optical disk is determined to be a DVD-R or DVD+R, or DVD-RW or DVD+RW based on the wobble frequency and the startup mode is set to each mode (S4207, etc.). Lock-in of the wobble-PLL (Phase Locked Loop) is confirmed (S4208, etc.). When the lock-in can be confirmed, the inserted optical disk 100 is determined to be a DVD-based optical disk (S4209, etc.), various information regarding the optical disk 100 (such as control information and ADIP information) are obtained (S4210, etc.), and the startup process is completed (S4400).

In the case of a DVD-based system also, when the focus servo or the tracking servo does not become the ON-state or the related information related to the inserted optical disk 100 such as the control information and the ADIP information cannot be obtained, the data processor 107 determines that the startup process is not completed. When the startup process is not completed, the data processor performs the process in step S105 on the flowchart of FIG. 2, that is, a narrow-down process of the startup modes.

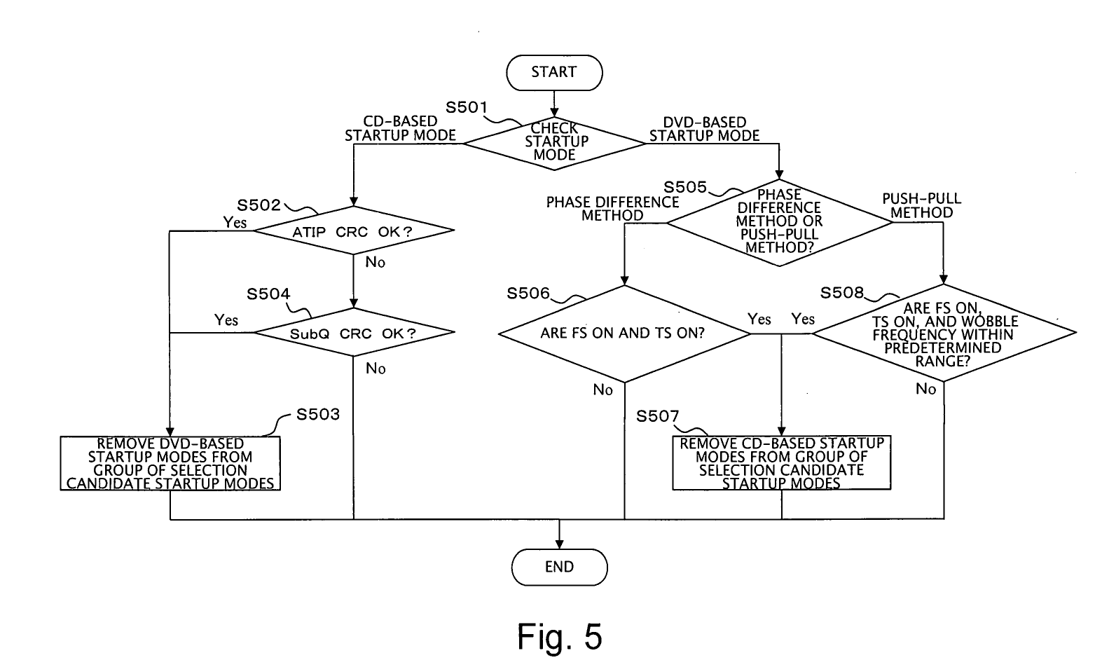

The narrow-down process of startup modes in the flowchart of FIG. 2 will now be described in detail referring to a flowchart shown in FIG. 5. This process is performed when a startup error occurs in a startup process in any of the startup modes shown in FIGS. 3 and 4 and the startup process is not completed in a normal manner.

When a startup error occurs, the data processor 107 checks whether the current startup mode is a CD-based startup mode or a DVD-based startup mode (S501). When the startup mode is a CD-based startup mode, it is determined whether or not a CRC error is present in the ATIP information obtained as one of the related information of the optical disk 100 during the startup process (S502). When there is no CRC error, because the inserted optical disk 100 is definitely a CD-based optical disk, the DVD-based startup modes, that is, the DVD high-reflection startup mode and the DVD low-reflection startup mode, are removed from the group of startup modes selected in the subsequent attempts (S503).

When a CRC error is found in the ATIP information in the determination of S502, it is determined whether or not there is a CRC error in the SubQ information obtained as one of the related information during the startup process (S504). When no CRC error is found, a startup mode removal process is performed at the step S503. When, on the other hand, a CRC error is found, it is determined that the inserted optical disk 100 cannot be determined to be a CD-based optical disk from the related information obtained during the startup process, startup modes are not removed, and the startup mode narrow-down process is completed.

When, on the other hand, the startup mode is a DVD-based startup mode in the determination of S501, the data processor 107 determines whether or not the setting of the startup mode is a phase difference method or push-pull method (S505). When it is determined that the startup mode is a phase difference method as a result of the determination, it is determined whether or not a startup error is generated even though the focus servo and the tracking servo become the ON-state during the startup process (S506). When it is determined as a result of the determination that a startup error has occurred, even though the focus servo and the tracking servo become the ON-state, the inserted optical disk 100 is at least definitely a DVD-based optical disk, and therefore, CD-based startup modes, that is, the CD high-reflection startup mode and the CD low-reflection startup modes, are removed from the group of startup modes to be selected in the subsequent attempts (S507).

When, on the other hand, it is determined that the startup mode is a push-pull method as a result of the determination at step S505, it is determined whether or not the focus servo and the tracking servo become the ON-state and the wobble frequency falls within a predetermined range showing a characteristic of a DVD-based system (for example, approximately 810 kHz for DVD+RW and approximately 140 kHz for DVD-RW) (S508) during the startup process, and when this is the case, because the inserted optical disk 100 is at least definitely a DVD-based disk, CD-based startup modes, that is, the CD high-reflection startup mode and the CD low-reflection startup mode, are removed from the group of startup modes selected in the subsequent attempts (S507).

In the present embodiment, when a startup error occurs during a startup process, the startup mode narrow-down process shown in FIG. 5 is performed, and then the data processor 107 determines whether or not there is a startup mode which has not been attempted from among the startup modes remaining after the narrow-down process (S106) as shown in the flowchart of FIG. 2. When it is determined, as a result of the determination, that there is a startup mode which has not been attempted, one of the startup modes that have not been attempted is selected (S107) and a startup process is performed. When, on the other hand, all startup modes have been already attempted, a notification of a disk error is instructed (S108), the disk error is notified on a display or the like provided on the optical disk device, and the startup process is interrupted.

The selection of the startup mode may be performed by, for example, defining an order to be selected, or priorities of the startup modes, in advance and selecting based on the priorities. When, for example, the startup mode where a startup error occurs is the CD high-reflection startup mode and the priority is defined to be the DVD high-reflection startup mode, the CD low-reflection startup mode, and the DVD low-reflection mode in that order from the highest priority to the lowest priority, the startup mode which is next selected is the DVD high-reflection startup mode. However, when the DVD-based startup modes are removed from the selection candidates in step S503 of FIG. 5, the selectable startup modes only include CD-based startup modes, and therefore, the startup mode to be selected next is the CD low-reflection startup mode.

In this manner, in the present embodiment, by narrowing down, when a startup error occurs, the candidates for the startup modes to be selected in the subsequent attempts based on the related information of the inserted disk which is obtained in the startup process, the time required for the startup process and for notification of the startup error can be reduced.

In the present embodiment, a configuration is described in which the startup mode in which a startup error occurred is only executed once. The present invention, however, is not limited to such a configuration, and may be configured such that a new startup mode from among the remaining startup modes that have not been attempted is attempted after the same startup mode is attempted a plurality of times.

In addition, in the above description, the presence of the CRC error in the ATIP information, etc. has been described as the identification method of the type of the optical disk. The present invention, however, is not limited to such a configuration and the narrow-down process may be performed using any related information as long as the type of the disk can be narrowed down using the related information regarding the disk which can be read from the inserted disk during the startup process. As an alternative, for example, a configuration may be employed in which, when the sector ID, LPP, and CAPA can be read, the inserted disk is determined as a DVD-based optical disk because these information are information unique to DVD-based disks. As another alternative, because the user data writing portion and the header portion on the track have differing reflectivities in a DVD-RAM, it is possible to employ a configuration in which, for example, the reflectivity on the track is detected and the inserted disk is determined to be a DVD-RAM when a high reflection portion is detected.

As described, according to the present embodiment, when a startup error occurs and the startup process is not completed in a normal manner, the data processor 107 narrows down the type of the optical disk such as, for example, whether the optical disk 100 is a CD-based optical disk or a DVD-based optical disk, based on related information related to the inserted optical disk 100 which is obtained during the startup process. Therefore, when a startup error occurs, the number of startup modes to be attempted in subsequent processes is reduced and the time required for identification of the type of the optical disk 100 and for notification of error can be reduced.

For example, when the inserted optical disk is a DVD-based optical disk, even when the disk is inserted into the optical disk device in an upside down or reversed orientation, the focus servo and the tracking servo may become ON-state and the wobble frequency may be determined as falling within a predetermined range. Then, in the subsequent step, for example, the step of obtaining the control information and the ADIP information, it is determined that the startup is not completed. In such a case, if the number of startup modes to be newly attempted is large, a long period of time would be required until an error is notified as a startup error. According to the present embodiment, however, because the CD-based startup modes are not attempted as the inserted disk is determined as at least a DVD-based optical disk when the focus servo and the tracking servo become ON-track state and the wobble frequency is determined to fall within the predetermined range, the time required until the notification of the startup error can be reduced.

What is claimed is:

1. An optical disk device which identifies among a plurality of types of optical disks and starts up, the optical disk device comprising:
an identification unit which identifies a type of an optical disk which is inserted;
a selection unit which selects a startup mode corresponding to an identified type of an optical disk from a storage device which stores a startup mode corresponding to a type of an optical disk;
a startup unit which performs a startup process based on a selected startup mode;
an obtaining unit which obtains related information related to the optical disk which is obtained during a startup process by the startup unit; and
a mode limiting unit which limits a group of startup modes to be selected by the selection unit from among a group of startup modes stored in the storage device based on obtained related information when a startup error occurs during the startup process, wherein
the selection unit selects a next startup mode from among the group of the startup modes limited by the mode limiting unit when a startup error occurs during the startup process.

2. An optical disk device according to claim 1, wherein
when the related information is information unique to a CD-based optical disk, the mode limiting unit limits the group of startup modes to CD-based startup modes.

3. An optical disk device according to claim 1, wherein
when the related information is information unique to a DVD-based optical disk, the mode limiting unit limits the group of startup modes to DVD-based startup modes.

4. A startup method of an optical disk in which the optical disk is identified from among a plurality of types of optical disks and is started up, the method comprising:
an identification step in which a type of an optical disk which is inserted is identified;
a selection step in which a startup mode corresponding to an identified type of an optical disk is selected from a storage device which stores a startup mode corresponding to a type of an optical disk;
a first startup step in which a startup process is performed based on a selected startup mode;
an obtaining step in which related information related to the optical disk which can be obtained during the startup process at the first startup step is obtained;
a mode limiting step in which a group of startup modes to be selected next is limited from among a group of startup modes stored in the storage device based on obtained related information when a startup error occurs during the startup process; and
a second startup step in which a next startup mode is selected from among the group of the startup modes limited in the mode limiting step when a startup error occurs during the startup process and a startup process is performed based on the selected startup mode.
